(19) United States
(12) Patent Application Publication
(10) Pub. No.: US 2002/0071233 A1
(43) Pub. Date: Jun. 13, 2002

(54) TVSS fuse combination

(76) Inventors: Larry Edward Bock, So. Glens Falls, NY (US); John Bernard Cozzens, JR., Queensbury, NY (US); Daniel Paul Korot, Queensbury, NY (US)

Correspondence Address: Philmore H. Colburn II, Cantor Colburn LLP, 55 Griffin Road South, Bloomfield, CT, 06002, US

(21) Appl. No.: 09/736,488

(22) Filed: Dec. 13, 2000

(51) Int. Cl. H02H 9/06

(52) U.S. Cl. 361/127; 361/117; 361/111

(57) ABSTRACT

A transient voltage surge suppressor (TVSS) having a fuse rated to withstand high transient surge currents is disclosed. The TVSS employs metal oxide varistors (MOV's) in close proximity to the fuse such that heat from failed MOV's is used to reduce the time required to blow the fuse. The fuse may be mounted to the metal bus connection of a MOV within a sand-filled or potted box containing the MOV's. Thus, the TVSS of the present invention utilizes a thermally assisted disconnect method which enhances the performance of the TVSS under unusual fault conditions.

### BACKGROUND OF THE INVENTION

The present invention relates generally to a Transient Voltage Surge Suppressor (TVSS) fuse combination, and more particularly this invention relates to the use of a fuse to match Metal Oxide Varistor (MOV) capability and providing enhanced protection in the event of an MOV failure.

Transient voltage surge suppression has become an important focus for commercial and industrial businesses because of the damaging effects transient voltages can incur upon sensitive equipment. Service interruption, data loss, or equipment damage/failure can bring severe consequences to the user's bottom line.

The addition of TVSS for new construction projects is very common. However, as existing facilities begin to upgrade, with sensitive equipment such as computers and microprocessor based control equipment, the need to protect is just as important. Existing facilities may be more prone to damage caused by surge events because they are more likely to be served by overhead service, and overhead conductors are more susceptible to lightning induced surge currents. Additionally, new electronic equipment can be sensitive to surge events caused by lightning or switching or inductive loads inside the facility. The addition of service entry TVSS and branch panel location TVSS can add surge suppression to existing distribution equipment.

In operation, TVSS devices limit the peak voltages occurring in power lines or electronic circuits since the components in computers and related equipment in these circuits can be damaged by a transient voltage condition resulting from a voltage surge. Strategic placement of TVSS devices mitigates the effect of voltage transients so they do not damage the system. Often, the device performs transient voltage suppression by functioning as a current diverter. In these instances, it presents a low impedance path for surge currents as compared to the impedance level of the protected circuits and equipment. Under normal operating conditions, a TVSS circuit has a high impedance and draws very little current. And, as the voltage applied across the circuit increases above the design voltage level, the impedance of the TVSS circuit dramatically falls. This is highly desirable, because, for effective surge current diversion, very low impedance is required.

Metal oxide varistors (MOVs) may be utilized within the TVSS device for effectively clamping the transient voltage to a level determined acceptable for the protected circuit. Potentially destructive surge energy is thereby dissipated or passed through the TVSS device and its operating current returns to its normal range after the surge. It is necessary to provide protection for TVSS units against component failures, i.e. failure of MOV components, which usually fail as short circuits, and most manufacturers use in-line fuses for this. The fuse then must also conduct all surge impulses since it is in series with the protectors. Adding a current fuse in series with the MOV, which trips to an open state to protect against MOV failures, is advantageous. However, it is desirable for the fuse to withstand transient surges without blowing so that it does not disconnect the TVSS from service needlessly. TVSS maximum surge ratings are typically 50 kA to 100 kA or more, the surges being a standard 8×20 μsec waveshape. There is a trade off between making the fuse as large as possible to withstand these transient surges, yet not so large that it is no longer protective for faults within the TVSS. UL Standard 1449 addresses this by requiring demonstration of protection with 15 kA 60 Hz available short circuit current. UL also requires a low current (5 amperes) long time test on failed MOVs to show that the assembly does not get hot enough to create a fire hazard. Failed MOVs can get extremely hot during this test as shorted MOV's still have some finite resistance, e.g. 0.03-0.2 Ohms, so the I²R watts generated can be significant.

The protective characteristics, the realistic maximum surge current rating on a complete unit, and the longevity of a TVSS are the fundamental characteristics of a TVSS that need to be maximized for developing a rugged heavy duty TVSS device.

### BRIEF SUMMARY OF THE INVENTION

The above discussed and other drawbacks and deficiencies are overcome or alleviated by a transient voltage surge suppressor having a thermally assisted disconnect, the transient voltage surge suppressor comprising a box, a metal oxide varistor within the box, a line connecting the metal oxide varistor to an exterior of the box, and, a fuse mounted within the box, wherein the fuse is positioned in close proximity to the metal oxide varistor for absorbing heat from the metal oxide varistor when the metal oxide varistor fails. A method of providing a thermally assisted disconnect for a transient voltage surge suppressor is further disclosed, the method comprising mounting a metal oxide varistor within a box, connecting the metal oxide varistor to a line extending outside of the box, selecting a fuse, mounting the fuse adjacent to the metal oxide varistor, generating heat in a failed metal oxide varistor from current in the line, absorbing the heat with the fuse, and blowing the fuse from the heat generated by the failed metal oxide varistor.

The above discussed and other features and advantages of the present invention will be appreciated and understood by those skilled in the art from the following detailed description and drawings.

### BRIEF DESCRIPTION OF THE DRAWINGS

Referring to the FIGURES wherein like elements are numbered alike in the several FIGURES:

FIG. 1 shows a top plan view of a fuse;

FIG. 2 shows a side plan view of the fuse of FIG. 1;

FIG. 3 shows a current vs. time table of a 100 kAmp 8×20 μsec surge;

FIG. 4 shows a perspective view of a panel mount transient voltage surge suppressor;

FIG. 5 shows a top plan view of a wall mounted transient voltage surge suppressor;

FIG. 6 shows a side cross-sectional view of the wall mounted transient voltage surge suppressor of FIG. 5;

FIG. 7 shows a top plan view of the wall mounted transient voltage surge suppressor of FIG. 5 with the door removed;

FIG. 8 shows a side perspective view of a box for holding metal oxide varistors;

FIG. 9 shows a circuit diagram of the fuse-metal oxide varistor combination in the transient voltage surge suppressor;

FIG. 10 shows a perspective interior view of the box of FIG. 8;

FIG. 11 shows a side perspective view of a metal oxide varistor;

FIG. 12 shows voltage readings experiencing a surge;

FIG. 13 shows circuit diagram of a protected electrical device experience a surge when connected to the transient voltage surge suppressor;

FIG. 14 shows a top view of a box of the present invention containing the MOV's, fuses, and metal bus; and,

FIG. 15 shows a side view of the box of FIG. 14.

### DETAILED DESCRIPTION OF THE INVENTION

Referring to FIG. 1, a fuse that can withstand a 100 kA 8/20 μsec transient is preferably used in the present invention as this rating more nearly matches MOV capability of the TVSS of the present invention. Many TVSS manufacturers use much smaller fuses than can only withstand up to 10 kA surges even though they claim 100 kA capability in their MOV design. This results in unwanted fuse blowing for moderate surges, which disconnects the TVSS and leaves equipment unprotected.

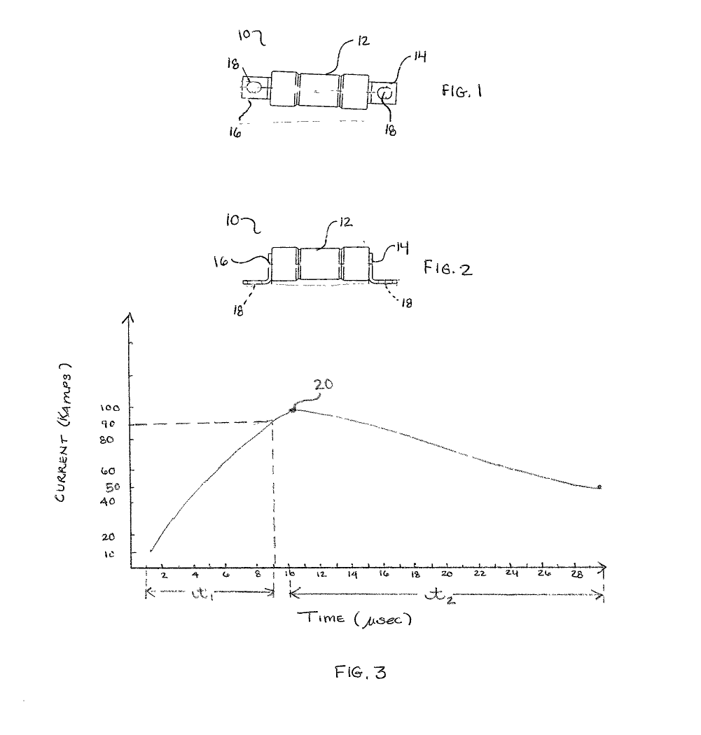

This 100 kA fuse 10, such as a VSP 100 brand by Gould Shawmut as shown in FIGS. 1-2, is shown in include a substantially cylindrical body 12 having a first connection strap 14 on a first end and a second connection strap 16 on a second end of the body 12. Each connection strap preferably includes an aperture 18 for receiving a connection device such as a screw. The fuse 10 is rated to withstand a 100 kA 8×20 μsec surge. In other words, as clearly shown in FIG. 3, when the surge has an 8 μsec rise time to a peak at 100,000 amps, as shown at crest 20, it will take 20 μsec to decrease to ½ that value. Rise time t₁ is defined as time between 10% and 90% of peak current. Decay or fall time t₂ is defined as time from peak to 50% of peak current. Although a 100 kA fuse is disclosed for use in the present inention, the inventive concept, as will be described below, will work with larger or smaller fuses as well.

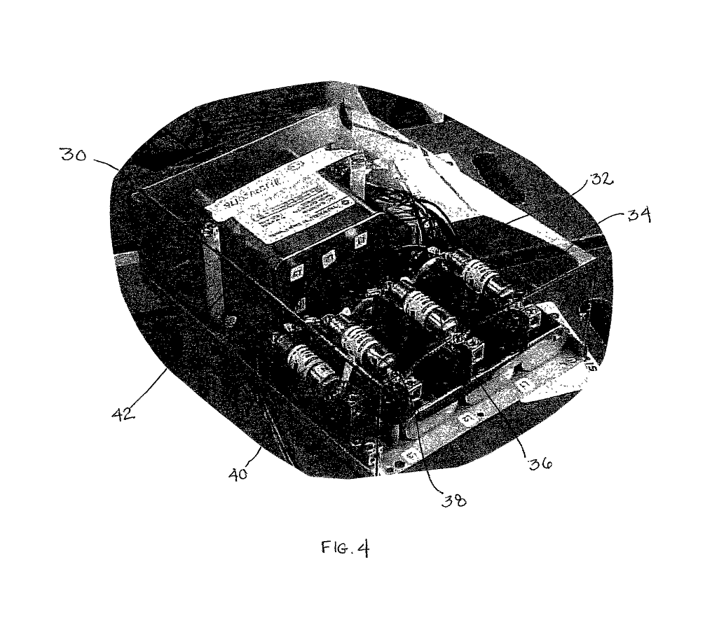

A panel mount TVSS 30, which does not include the present invention, as shown in FIG. 4, which may be installed in a load center, is shown to include a plurality of fuses, shown collectively at 32, in this instance four, connected to a metal, sand-filled box 42 containing MOV's. Three of the fuses 34, 36, and 38 connect separately to three separate lines, while a fourth fuse 40 connects to the neutral. Other parts of the panel mount TVSS 30 may include an emi (electro magnetic interference) transient filter (the three capacitors located under the fuses), a surge counter, and indicating lights or a horn alarm to indicate if a fuse has blown.

The surge counter will respond to and record surges via a current transformer in the neutral circuit. The counter may be reset to zero if desired. Should a fuse blow, its indicating light will extinguish and the audible alarm will sound. The alarm may be silenced by depressing a reset button, which will preferably continue to be lit after silencing.

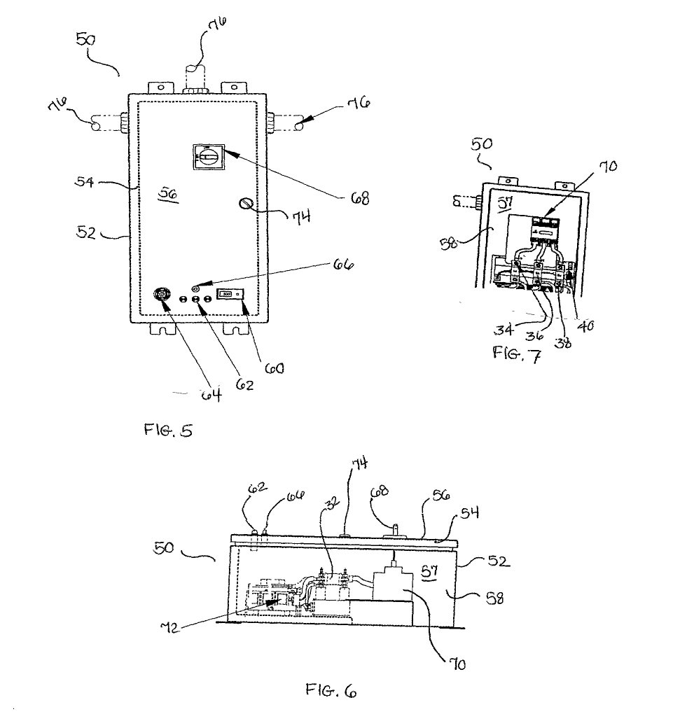

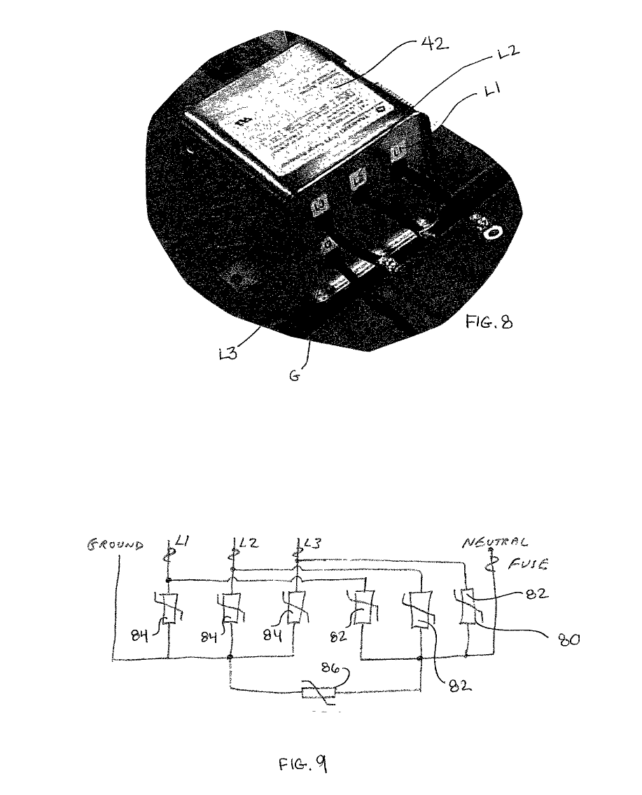

A wall mounted TVSS 50, which does not include the present invention, as shown in FIGS. 5-7, is similar to panel mount TVSS 30 but is housed in an enclosed box 52, not to be confused with box 42 containing MOV's, which is also included in TVSS 50. The wall mounted TVSS 50 as shown includes an outer surface 56 of a hinged door 54 of the box 52 upon which is supplied a surge counter 60. Also included on the outer surface 56 of hinged door 54 are indicating lights 62 and a horn alarm 64 for indicating if a fuse has blown. A horn reset button 66 is provided for resetting the horn 64 and a disconnect switch 68 is provided for disconnecting the TVSS 50 from service. The interior 57 within the casing 58 of the box 52 of the TVSS 50 includes the electronic substructures (not shown) for the alarm horn 64, indicator lights 62 and the surge counter 60 connected to the hinged door 54. The disconnect switch 68 extends within the interior 57 for connection to a phase connection block 70. Fuses 34, 36, 38 for phase connection and fuse 40 for ground to neutral connection are further shown within the interior 57, as are contacts 72. The TVSS 50 may be installed at three possible conduit locations 76 as shown, and restricted access within the interior 57 of the TVSS 50 may be provided by lock 74 on hinged door 54.

The panel mount TVSS 30 shown in FIG. 4 and wall mounted TVSS 50 shown in FIG. 5 are two general types of hard-wired TVSS. As described below, the fuses of the present invention are preferably mounted within the box 42 to benefit from the heat generated by a failed MOV, as opposed to outside of the box 42, isolated from the MOV's. The TVSS of the present invention may be panel mounted, wall mounted, or other configuration within the scope of this invention.

Turning to FIG. 8, the fuses 32 are connected within the metal sand-filled box 42 with MOV's 80. The box shown is usable in a 3 phase power TVSS, because it is provided with access to three lines (L1, L2, and L3), and an additional access to a ground line (G). As further shown in FIG. 9, the metal, sand-filled box 42 is a “7-mode” device, with MOV protection provided for each phase to neutral 82, each phase to ground 84, and between neutral and ground 86, thus 7 MOV's 80. Although metal sand-filled box 42 is shown, other materials for constructing the box could be used, such as plastic, and other material for filling the box, such as a potting compound, could be used. It should also be noted that although a 7-mode device is described, a TVSS can have from on to ten modes, and the inventive concept will work with any number of modes.

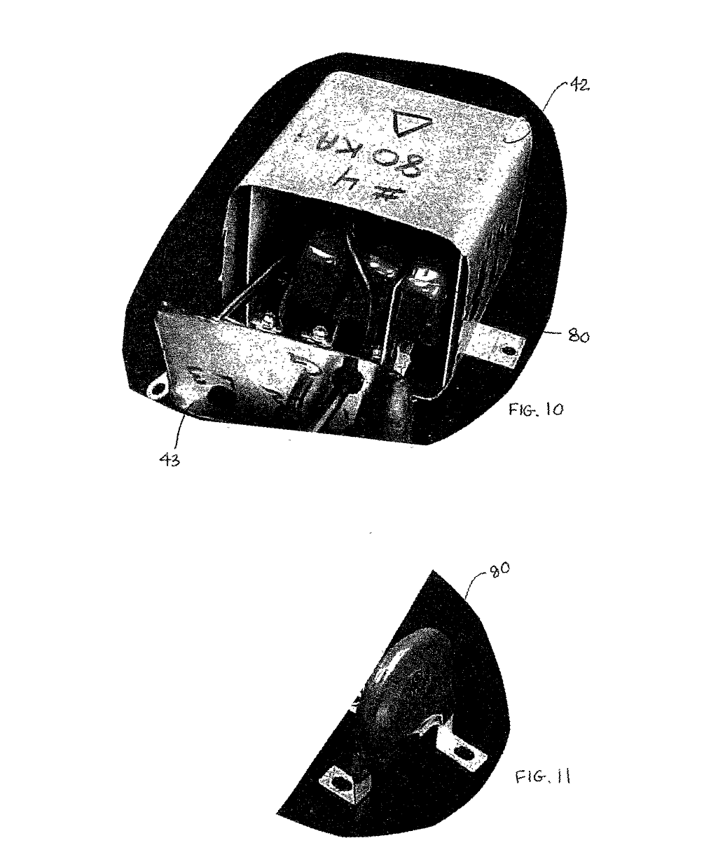

As shown in FIG. 10, the MOV's 80 are stacked inside of the box 42, in this case in two rows: a first row of three MOV's 80 nearest the cover 43, and a second row of four MOV's 80 (not fully shown). The sand from the box in FIG. 10 is not shown for clarity in viewing the MOV's 80. A singular MOV 80 is shown in FIG. 11. It should be understood that the present invention is not limited to size or number of MOV's. For example, the invention could utilize 2 parallel large MOV's, or instead, 10 or more small MOV's, or other variable combination. In one embodiment of the invention, the fuses 32 are mounted within the box 42. Thus, if an MOV 80 fails, it will heat from short circuit current and the heat will hasten fuse blowing. The fuses 32 may be mounted directly on the metal bus that the MOV 80 is connected to inside the box 42 (e.g. bus 102 in FIG. 15). If fault current is reasonably high, then the fuse 32 will blow quickly. If the fault current is lower, for example due to a poor connection externally, then the MOV 80 can become very hot while waiting for the fuse 32 to blow.

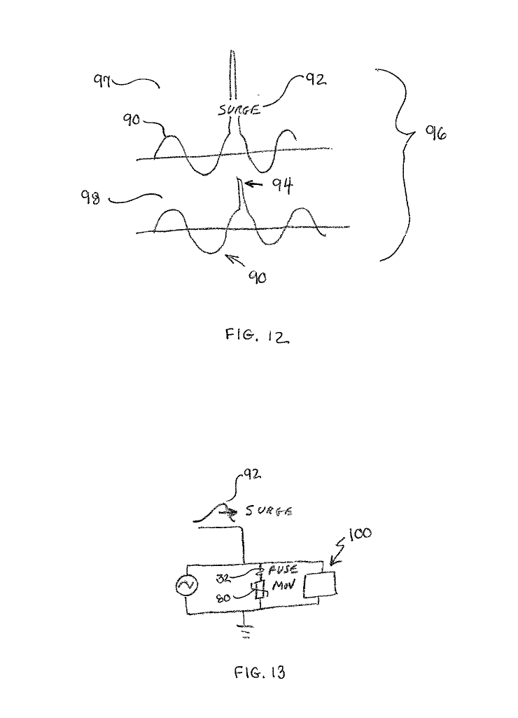

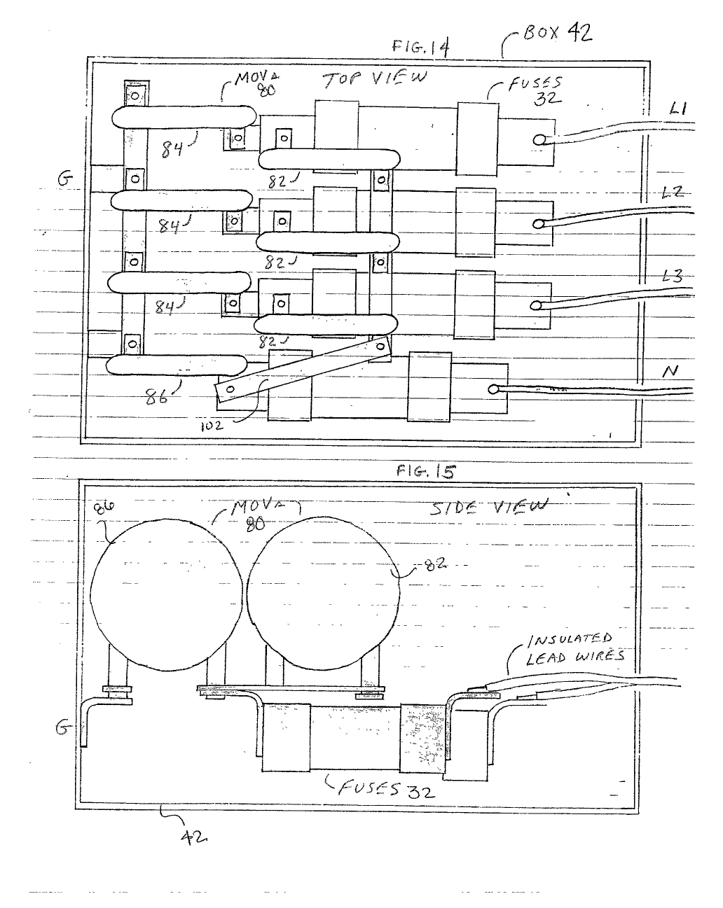

FIG. 12 shows voltage readings 96 demonstrating the differences in voltage between an unprotected circuit and a circuit having TVSS protection. As shown, when the unprotected circuit shown in reading 97 experiences a surge 92, the otherwise normal voltage 90 increases to an unsafe level for the electrical equipment connected to the circuit. When the protected circuit shown in reading 98 experiences a surge, the voltage increases to a predetermined level higher than the normal voltage 90 and is then clamped at voltage 94 by an MOV 80. MOV's 80 are highly nonlinear resistors. Their impedance decreases as voltage increases, therefore they act to limit peak voltages by conducting current. A surge is shown in FIG. 13 in which both the fuse 32 and the MOV 80 must conduct the surge current 92 for continuous protection of the connected equipment 100.

To demonstrate the effectiveness of the present invention, a number of tests were performed on the fuses in both an open, isolated configuration (as in conventional designs where the fuse is not exposed to the heat generated by a failed MOV) and in a metal, sand filled box as shown in FIGS. 14 and 15. The MOV's for these tests were pre-failed by subjecting them to a sustained 60 Hz overvoltage to induce failure.

Tests at 300 amperes on isolated fuses at room temperature, approximately 25 Degrees C, had an average melting time of 124 seconds. The average melting time at 300 amperes with a 100 Degree C temperature was 69 seconds, a 44% reduction in melt time. The average melting time with a 200 Degree C temperature was 28 seconds, a 77% reduction in melt time. This clearly demonstrates that the fuses will melt faster at elevated ambient temperatures.

One isolated fuse was tested at 150 amperes at room temperature, and it melted in 3 hours 37.5 minutes (13,050 seconds). The configuration of the present invention with the fuses exposed to the heat of the failed MOV was also tested at 150 amperes at room temperature, and the fuse melting times ranged from 1260 to 10,200 seconds, reductions in melt time of 22% to 90%. At 100 amperes (a level below the minimum melting current for isolated fuses) the average melting time for the samples was 5700 seconds.

It should be noted that the melting time will be somewhat variable with the present invention because the equivalent resistance of the failed MOV's, and thus the wattage and heat generated by the MOV is variable. Nevertheless, the above data clearly shows significant reductions in melting time as well as in the minimum current required to melt the fuse in the present invention. These are desirable enhancements in a TVSS design.

Thus, the present invention provides a thermally assisted disconnect for the TVSS enhancing its performance for unusual fault conditions where the short circuit current is not sufficient to rapidly operate the fuse 32. A 100 kA fuse is preferably mounted in the sand-filled box 42 containing the MOV's 80 such as by using the metal bus connections to efficiently conduct heat from the MOV's 80 to the fuse 32. By using the larger rated fuse, the TVSS of the present invention is able to withstand large transient surges without spurious fuse blowing. The enhancements of the present invention improve over the prior use of such larger rated fuses by making the TVSS more protective against faults. The inventive placement of the fuses and the use of heat from the failed MOV's to blow the fuses 32 (as opposed to merely the fault current itself) thus enables the TVSS of the present invention to be more protective against short circuits as well as able to withstand transient surges without blowing needlessly.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. For example, the enclosure for the MOV's is described as a metal box, but it could be plastic or other suitable material. Similarly, the MOV's are surrounded by sand in this description, as this is an inexpensive heat transer medium, but the MOV's and fused could also be enclosed in a number of other potting materials, for example urethane. Therefore, it is intended that the invention not be limited to the particular embodiment disclosed as the best mode contemplated for carrying out this invention, but that the invention will include all embodiments falling within the scope of the appended claims.

What is claimed is:

1. A transient voltage surge suppressor having a thermally assisted disconnect, the transient voltage surge suppressor comprising:
a box;
a metal oxide varistor within the box;
a line connecting the metal oxide varistor to an exterior of the box; and, a fuse mounted within the box, wherein the fuse is positioned in close proximity to the metal oxide varistor for absorbing heat from the metal oxide varistor when the metal oxide varistor fails.

2. The transient voltage surge suppressor of claim 1 wherein the fuse is rated to withstand a 100 kA 8×20 μsec surge.

3. The transient voltage surge suppressor of claim 1 wherein the metal oxide varistor includes a metal bus connection and wherein the fuse is connected to the metal bus connection.

4. The transient voltage surge suppressor of claim 3 wherein heat from a failed metal oxide varistor is transferable to the fuse over the metal bus connection.

5. The transient voltage surge suppressor of claim 1 wherein the box is filled with sand.

6. The transient voltage surge suppressor of claim 1 wherein the box is filled with a potting compound.

7. The transient voltage surge suppressor of claim 1 comprising a plurality of lines, a neutral, and a connection to ground, a fuse rated to withstand a 100 kA 8×20 μsec surge for each line and a fuse rated to withstand a 100 kA 8×20 μsec surge for neutral.

8. The transient voltage surge suppressor of claim 7 comprising a plurality of metal oxide varistors, wherein the plurality of metal oxide varistors includes a metal oxide varistor for connecting each line to ground, a metal oxide varistor for connecting each line to neutral, and a metal oxide varistor for connecting ground to neutral.

9. A method of providing a thermally assisted disconnect for a transient voltage surge suppressor, the method comprising:
mounting a metal oxide varistor within a box;
connecting the metal oxide varistor to a line extending outside of the box;
selecting a fuse;
mounting the fuse adjacent to the metal oxide varistor;
generating heat in a failed metal oxide varistor from current in the line;
absorbing the heat with the fuse; and, blowing the fuse from the heat generated by the failed metal oxide varistor.

10. The method of claim 9 wherein mounting the fuse comprises attaching the fuse to a metal bus connection of the metal oxide varistor.

11. The method of claim 10 wherein absorbing the heat with the fuse comprises transferring the heat from the failed MOV over the metal bus connection to the fuse.

12. The method of claim 9 wherein absorbing the heat with the fuse comprises absorbing the heat from the failed MOV through a raised ambient temperature within the box.

13. The method of claim 9 wherein selecting a fuse comprises selecting a fuse rated to withstand a 100 kA 8×20 μsec surge.

14. The method of claim 9 further comprising filling the box with a potting compound or sand.

15. The method of claim 9 wherein mounting the fuse adjacent to the metal oxide varistor comprises mounting the fuse within the box.

16. A transient voltage surge suppressor having a thermally assisted disconnect, the transient voltage surge suppressor comprising:
a box;
a metal oxide varistor within the box;
a line connecting the metal oxide varistor to an exterior of the box; and,
a fuse rated to withstand a 100 kA 8×20 μsec surge.

17. The transient voltage surge suppressor of claim 16 wherein the fuse is located within the box.

18. The transient voltage surge suppressor of claim 17 wherein the metal oxide varistor includes a metal bus connection and wherein the fuse is connected to the metal bus connection.

19. The transient voltage surge suppressor of claim 16 wherein the box is filled with sand.

20. The transient voltage surge suppressor of claim 16 wherein the box is filled with a potting compound.

21. The transient voltage surge suppressor of claim 16 comprising a plurality of lines, a neutral, and a connection to ground, a fuse rated to withstand a 100 kA 8×20 μsec surge for each line and a fuse rated to withstand a 100 kA 8×20 μsec surge for neutral.

22. The transient voltage surge suppressor of claim 21 comprising a plurality of metal oxide varistors, wherein the plurality of metal oxide varistors includes a metal oxide varistor for connecting each line to ground, a metal oxide varistor for connecting each line to neutral, and a metal oxide varistor for connecting ground to neutral.
